(19) United States
(12) Patent Application Publication
(10) Pub. No.: US 2005/0268150 A1
(43) Pub. Date: Dec. 1, 2005

(54) Routing method and network element

(76) Inventors: Francisca Llabres, Benalmadena Costa-Malagal (ES); Fabio Longoni, Malaga (ES)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/518,912

(22) PCT Filed: Jun. 25, 2002
(86) PCT No.: PCT/IB02/02459

§ 371 Date: Dec. 23, 2004

(51) Int. Cl. G06F 11/00

(52) U.S. Cl. 714/4

(57) ABSTRACT

The present invention relates to a method and network system for direct routing of the user plane of a call between two network terminals attached to a first and a second access network, respectively. After establishing the call, the transmission path for user data is changed such that it only comprises the access networks. Relocation between access network elements for such a Direct Routed call is disclosed. The methods described are applicable for circuit-switched as well as packet-switched connection types and especially effective for all IP network situations. Furthermore, the invention relates to a network element, such as a Radio Network Controller, adapted to operation according to the method mentioned above.

### FIELD OF THE INVENTION

The present invention relates to a routing method and a network element. It also relates to a network system.

### BACKGROUND OF THE INVENTION

Establishing a call for terminal devices often involves an access network and a core network, like in the case of mobile telephones or portable computers with installed software modules for access to network services.

A call in this context is a logical association between two or more terminal devices. A terminal device is a device allowing a user to access network services. An access network is a telecommunication network allowing a user to access network services using a terminal device.

An access network is adapted to a certain connection technology of a terminal device originating the data, for instance a wireless connection technology based on a certain radio signaling standard, or a cable connection technology based on electrical or optical signaling according to a certain signaling standard. Different kinds of Radio access networks (RAN) are for example the Universal Terrestrial Radio Access Network (UTRAN), the Internet Protocol (IP) based IP RAN and the Global System for Mobile Communications Base Station Subsystem (GSM BSS). Examples for cable based access networks are an ISDN telephone network and a power-line access network providing communication channels through electrical power cables.

In contrast, a core network is a network allowing data transmission regardless of the connection technology of the terminal device originating the data.

Call establishment procedures involve establishing a control connection between the terminal devices involved and establishing a connection for transport of user data. Finding and establishing the appropriate transmission path for the respective data is referred to as routing. User data is all information sent and received by a user, such as coded voice in a voice call or packets in an Internet connection. Establishing a call between, e.g., two terminal devices, involves the access network and core network on the side of the network terminal originating the call as well as the core network and the access network on the side of the network terminal terminating the call.

According to present protocol models, user data and control data related to a certain call are transported independently of each other through the networks involved. Accordingly, a control plane and a user plane are distinguished in the protocols. Control Plane protocols control radio access bearers and the connection between the network terminal and the network (including requesting the service, controlling different transmission resources, handover, streamlining, etc).

User data are transported (routed) in the user plane between the RAN and the CN. The user plane is responsible for the protocols implementing the actual radio access bearer service, i.e., carrying user data through the access stratum. The user plane includes the data stream(s) and the data bearer(s) for the data stream(s). Data streams are characterized by one or more frame protocols.

With in increasing usage of the networks by an ever-increasing number of users and demanding applications there is a need for optimizing the resources used by a call.

### SUMMARY OF THE INVENTION

It is therefore an object of the present invention to provide a method and a network system that allow reducing the use of access and core network resources by a call. It is also an object of the invention to provide a network element allowing to optimize the use of access and core network resources, also in cases when a network terminal attached to the access networks is moving.

This object is achieved by a method according to claim 1, a method according to claim 37, a network element according to claim 45 and a network system according to claim 49.

The method of the invention is based on the observation that a transmission path involving core network resources is not necessary in many situations for user data related to a call. The basic idea of the invention is, therefore, to make the transmission path for user data related to a call shorter. According to the method of the invention, for user data related to a call involving a first terminal device attached to a first access network, and a second terminal device attached to a second access network, user data are transmitted directly between the access networks. After the method of the invention, a first transmission path for user data related to a call is first established according to known procedures. Then the transmission path for user data is changed to direct transmission between the access networks involved in the call.

Next, the method of the invention will be explained in further detail. As mentioned above, the method of the invention comprises a step of establishing a first transmission path for user data. This first transmission path comprises the first access network, a first core network communicating with said first access network, a second core network communicating with said first core network, and said second access network communicating with said second core network.

The step of establishing the first transmission path for user data uses well-known procedures, depending on the type of access and core network. The procedure will vary, for instance, when instead of a circuit-switched connection type a packet-switched connection type is used.

There may be additional telecommunication networks involved in the transmission path for the user data. For instance, there may be one or more transport networks through which the core networks communicate with each other.

Finally, the method of the invention comprises a step of switching from said first transmission path to a second transmission path for the user data. The second transmission path comprises a direct connection between the first access network and the second access network. Thus, after switching form the first to the second transmission path the user data are routed directly between the access networks. The core networks are not involved anymore in the transmission of the user data from between the originating and terminating network terminals.

By applying the method of the invention the usage the transport resources for user data is improved. Note that the method is applicable also when in the first transmission path for user data the first and second core networks are identical. Also, first and second access networks may be identical.

The method of the invention is applicable for calls involving the circuit-switched (CS) domain as well as the packet-switched (PS) domain. The term CS domain refers to the set of all the CN entities offering “CS type of connection” for user traffic as well as all the entities supporting the related signaling. A “CS type of connection” is a connection for which dedicated network resources are allocated at the connection establishment and released at the connection release. The term PS domain refers to the set of all the CN entities offering “PS type of connection” for user traffic as well as all the entities supporting the related signaling. A “PS type of connection” transports the user information using autonomous concatenation of bits called packets: each packet can be routed independently from the previous one.

The method of the invention provides savings on transmission and transport especially over the IP RAN. Is giving a reduced bandwidth for the transmission in the backbone, and also in the access network, depending on the number of calls between MSs camping on the same IP BTS or IP BTSs chain/tree.

This method of the invention is providing an optimal use of the non-hierarchical IP network, as only the minimum required paths for the transmission are used (not conditioned with the CN route to be followed).

With the method according to the invention a reduced delay is achieved in the CS speech calls and in the PS calls. Keeping the same delay budget it allows increasing the DiffServ buffering delay (saving bandwidth), the flow aggregation for IP header compression, etc.

Also this solution provides NE HW savings. MGW and CSGW resources are saved for the CS case, and RNGW and SGSN/GGSN resources are saved for the PS case, for example, in the percentage of the number of Direct Routed calls.

In a preferred embodiment, before said step of establishing said first transmission path for said user data, a step of establishing a third transmission path for control data related to said call is performed. That is, a call in the context of this embodiment refers to a connection-oriented association between the originating and the terminating network terminal. A connection-oriented association requires a connection before information can be exchanged. I.e., initial handshaking procedures are involved in establishing the call. An example for a connection-oriented association between two end-points is a speech call from one mobile telephone to another. Another example is a connection between two mobile computers attached to radio access networks.

In this embodiment, said third transmission path preferably comprises the same networks as said first transmission path for user data.

Furthermore, said third transmission path preferably remains unchanged before and after said step of switching from said first transmission path to said second transmission path. The idea behind this embodiment is that the control data flows for the call remain the same, still routed via the core networks. But the user data transmission path is optimized by a direct connection between the first an second access-network elements.

In a most preferred embodiment, said first, second, and third transmission paths involve a first access-network element in said first access network, and a second access-network element in said second access-network. That is, the first access network element and the second network element are involved in the transmission of user data as well as control information before and after the change of the transmission path for user data. It is between these two access-network elements, that the direct transmission is established.

This embodiment provides a mechanism to route directly, between access network elements like IP BTSs, RNCs or BSCs, the user plane for Iu CS speech calls, and Iu PS calls (voice over IP). It is most preferably applied within an All-IP RAN. This embodiment obviates MS to MS CS speech calls and MS to MS PS calls (voice over IP) to route its user plane data through the CN and allows this user plane data to be routed directly between the access networks, e.g., between IP BTSs in case of a IP RAN. This is an important enhancement for the user plane transport part.

Before said step of switching from said first transmission path to said second transmission path for said user data, preferably a step of performing a handshake between the first and second access-network elements is performed. As a part of the handshake, another preferred embodiment of the invention comprises a step of providing first control information to at least a first access-network element involved in said first transmission path in said first access network and/or to at least a second access-network element involved in said first transmission path in said second access network, said first control information indicating that direct transmission of user data between said first and second access networks is possible.

A network element in this context is a telecommunications entity, which can be managed over a specific interface, such as a Radio Network Controller (RNC) in a UTRAN, an IP BTS (Internet Protocol Base Transceiver Station), or a BSC (Base Station Controller).

The background of this embodiment is that switching of the transmission path for user data may not always be possible. For example, during a circuit-switched speech call, switching the transmission path for user data to a direct transmission is not possible path if core network resources are mandatory for the transmission. One situation, in which core network resources are mandatory, is when the core network must provide transcoder services. This happens when the coding used for the user data of the originating terminal device cannot be decoded by the terminating terminal device, or vice versa.

According to the present embodiment, the first and second access-network elements (, e.g., IB BTSs) are enabled to negotiate the use of direct transmission. This embodiment is based on concepts of Transcoder free operation (TrFO) and Out of Band Transcoder Control (OoBTC) concepts for CS connections. A circuit-switched type of connection is a connection for which dedicated network resources are allocated at connection establishment and released at connection release.

During establishment of a call, a step of negotiating a mechanism of coding and decoding of user data between the networks is performed. TrFO is a configuration of CS speech calls between two terminal devices, for which a common coding/decoding mechanism (a codec) can be used. That means that no transcoder device is physically present in the first transmission path for user data involved in the connection between source codecs. OoBTC is the capability of a system to negotiate the types of codecs and codec modes on a call per call basis through out-of-band signaling, required to establish TrFO. However, the applicability of the present embodiment is not limited to CS transport. It can also be applied to every access network, especially every radio access network, for instance, in calls using a packet-switched transport technology. It is in deed more meaningful for an IP RAN.

The first control information may be provided to more than one access-network element in the first access network. The same holds for the second access-network element in the second access network. This applies for instance in a situation when there are two access-network elements in charge of a connection. In a UTRAN (Universal Terrestrial Radio Access Network), this situation is met when in relation to a connection one RNC is a serving RNC and another RNC is a drift RNC. Here, both RNCs may be provided with the first control information.

Providing the first control information is preferably done by a step of transferring the first control information from the first access-network element to the second access-network element. As an alternative, however, it may also be provided by transferring the first control information from a first core-network element to said first access-network element. For example, a Mobile-Services Switching Center (MSC). An MSC constitutes the interface between the radio access network and the core network. It performs all necessary functions in order to handle CS service to and from mobile stations.

The first control information may in parallel be transferred from a second core-network element in said second core network to said second access-network element.

In a further preferred embodiment, the step of providing first control information comprises a step of transferring second control information from said second access-network element to said first access-network element, or vice versa, said second control information containing a transport address of said second or first access-network element, respectively.

This embodiment also includes the case in which only the transport address transferred between the first and second access-network elements. That is, the first control information is implicitly contained in the second control information. By sending the transport address the sending access-network element indicates to the receiving access-network element that changing the transmission path for user data is possible.

In this embodiment, before said step of switching from said first transmission path to said second transmission path for said user data, preferably a step of responding to said second control information is included, by transferring third control information from the access-network element receiving said second control information to the access-network element sending said second control information. The third control information contains a transport address of the respective access-network element having received the second control information. This way the access-network element receiving the transport address of the sending element indicates that it is ready for switching to the direct transmission of user data between the access networks involved in the call. At the same time the information needed for direct transmission, i.e., the second transport address is provided to the other network element. This is an especially economical way of signaling between the two access-network nodes.

After switching from said first transmission path to said second transmission path an second access-network element preferably gives notice of the successful switching operation to its respective core networks. This step may be performed on the side of the originating network terminal and/or on the side of the terminating network terminal. Notice is given by transferring fourth control information from the access-network element to the respective core-network element. This will allow the core networks to use the resources saved for the first transmission path for other calls. For this, the fourth control information is preferably forwarded to other core network instances involved in providing resources for the first transmission path for user data. Thus, the capacity of the core networks may be used more efficiently in this embodiment.

In a further preferred embodiment, after said step of switching from the first transmission path to said second transmission path for user data related to a call, a step switching back to the first transmission path is performed under predetermined conditions.

Direct Routed calls shall be switched back to normal operation (user plane routed via the CN), when core network (CN) functions are needed within the call. These CN functions are:
a) Announcements. These are normally performed at the beginning of the call. So a requirement for Direct Routed calls is to establish them only after the terminating side connects. Also, these announcements can be performed during the call, for example in case a pre-paid user running out of money.
b) Tones. These are normally performed at the beginning of the call (ringing tone, subscriber busy, etc). Therefore, a requirement for establishment of a Direct Routed call is to establish it after the terminating side connects. Also these announcements can be performed during the call (for example call drop advise, etc). This limitation could be solved if the access-network elements could generate the tones.
c) Supplementary Services. These services can be requested during the call. Examples are: Conference Call, Call Wait, Call Hold and Explicit Call Transfer.
d) Lawful Interception. This service can be requested during the call.

Again, handshaking will be necessary to initiate the step back to the original transmission path for user data. Therefore, In this embodiment, before switching back to the first transmission path, preferably a step of transferring fifth control information from the first core-network element and/or said second core-network element to the first access-network element and/or said second access-network element is performed, respectively. With this fifth control information a request to switch back the transmission path for user data to said first transmission path is indicated.

To make the handshake complete, this is preferably answered using a step of transferring sixth control information from the access-network element receiving said fifth control information to the other access-network element involved in said second transmission path. The sixth control information indicates a request to switch back the transmission path of user data to said first transmission path.

This may in a further embodiment be answered using a seventh control information indicating that the coming switch back of the transmission path of user data to said first transmission path is acknowledged.

After switching back to the first transmission path the first and/or second core network elements are preferably informed of this step by transferring eighth control information indicating that switching back has been performed successfully.

In an embodiment especially applicable for CS connections, the mentioned step of providing first control information is performed during the step of establishing a third transmission path for control data related to said call.

In another embodiment, authorization to switch to said direct transmission is given by the first and/or second core-network elements to said first and/or second access-network elements, respectively. This is done before the switching, using a step of transferring corresponding tenth control information.

In an embodiment where the call is of a packet-switched connection type the step of transferring said first control information from said first access-network element to said second access-network element is performed using the first transmission path for user data. In this embodiment, the first control information is contained in a first data packet transferred between the first and second access-network elements after establishing the first transmission path. The first data packet is, for instance, a G-PDU. A G-PDU is a user data message. It contains a T-PDU (Transfer Protocol Data Unit) and a GTP (GPRS Tunneling Protocol) header.

A first advantage of this embodiment is similar to that of the CS case: In a normal IP RAN PS call, the user plane is routed via the CN. In a Direct Routed IP RAN PS call, the user plane is routed directly between the access networks. This type of call configuration saves transport resources in the core network. A further important advantage is that direct routing a PS call according to this embodiment reduces the delay of the voice over IP transmission.

In this embodiment, furthermore, the first and/or second control information is contained in at least one extension header of the first data packet. Again, the second control information comprises the transport address of the access-network element sending said first data packet.

When transferred from the first to the second core network, forwarding the first control information comprises copying the extension header to a second data packet transferred between the core networks.

In the packet switched case, responding to the second control information containing a access-network transport address involves a step of transferring back the other access-network transport address in a third data packet. A RNSAP handshake may be used for establishing the direct connection, as will be described below with reference to FIG. 5.

A further aspect of the present invention that is, however, essentially independent from those presented above is a method for redirection of a direct transmission path for user data related to a call involving a first terminal device attached to a first access network and a second terminal device attached to a second access network.

A direct transmission path for user data is a transmission path as established by the method of the invention described above, thus, involves direct routing of user data between access networks, especially access network elements such as a RNC or a IP BTS.

In the present method of the invention the direct transmission path for user data before the redirection comprises a first access-network element in said first access network directly communicating with a second access-network element in said second access network.

After the redirection by the method of the invention the direct transmission path for user data comprises the first access-network element in said first access network directly communicating with a third access-network element in said second access network. Thus, by the method of the invention, the role of the second access network element is taken by the third network element. The third access network element may have served in support of the second access network element in regard to the call until the method of the invention is performed.

The present method comprises a step of establishing a first transmission path segment for user data between the first access network element and the third access-network element. A segment of the transmission path in this context is a part of the transmission path for user data between two network elements. These network elements are, or become, respectively, part of the transmission path as a whole. The transmission path as a whole has its origin at one terminal station and terminates at the peer terminal station(s) of the call.

Thus, by establishing the transmission path segment between the first access-network element and the third access-network element an alternative transmission path for user data is established that allows to replace the second access-network element by the third access-network element in the direct transmission path for user data.

Furthermore, the present method of the invention comprises a step of releasing a second transmission path segment for user data between said first access-network element and said second access-network element.

It is important to note before and after performing the method of the invention the transmission path for user data is direct, i.e., the core networks are not involved in the transmission of user data between the terminal stations of the call.

Thus, this present method of the invention concerns the situation when direct routing as described above is first established for a call and then the transmission path of user data is changed. Such redirection is needed for instance in situations when one of the terminal devices is moving out off a service area of an access network element. A typical example is that of relocation. The present method may therefore be used as an access-network element (e.g., RNC, IP BTS) relocation method for Direct Routed calls.

In a preferred embodiment of this method the step of establishing a first transmission path segment for user data comprises a step of performing a handshake between said first access network element and said third access-network element. The handshake involves exchanging control information that makes sure a connection between the first and third access-network elements is working before user data are sent. It therefore helps to avoid the loss of user data in the process of changing the direct transmission path, e.g., a relocation process.

In a further embodiment, before said step of performing a handshake, a step of providing said third access-network element with eleventh control information is performed. The eleventh control information indicates to the third access-network that said redirection is requested.

In this embodiment, providing eleventh control information to the third access-network element may involve a step of transmitting said eleventh control information from a fourth access-network element in said second access-network to said third access-network element. That fourth access-network element provides control data transmission at the interface between the access network and the core network. In an IP Radio Access Network the fourth network element will be a Radio Network Access Server (RNAS).

Preferably, said eleventh control information contains a second information element indicating that said first transmission path segment is part of a direct transmission path. This may trigger the third access-network element to use implemented methods of establishing a direct connection for user data, as described herein, to the first access-network node, that is, without involving the core networks.

The eleventh control information contains in a further embodiment a transport address of said first access-network element. This may be as an alternative or in addition to the second information element. The transmission of this transport address alone may even already indicate to the third access-network element, that the call is a direct-routed call.

The step of providing said third access-network element with eleventh control information comprises in a further embodiment of the present method of the invention a step of transmitting twelfth control information from said second access-network element to said fourth access-network element, said twelfth control information indicating that said redirection is required by said second access-network element. This is useful for instance when the second access-network element detects that the radio transmission between the terminal station and the access network is not working well due to a position change of the terminal station.

Preferably, a transparent container is used in transmitting said second information element and/or said transport address from said second access-network element to said third access-network element with said eleventh and twelfth control information.

Further advantageous developments of the method of the invention are defined in the dependent claims.

According to another aspect of the invention, the problem is solved by a first network element for controlling the operation of at least one transceiver station in a first access network in relation to a call between a first network terminal attached to said first access network and a second network terminal attached to said first access network or to a second access network.

The network element of the invention comprises at least one first interface adapted to exchange control information and user data with said transceiver station. Furthermore, at least one second interface is provided adapted to exchange control information and user data with a first core-network.

The network element further comprises a first call control unit connected to said first interface. The first call control unit is adapted to establish, maintain and release across said first interface and in relation to said call a first control-channel section for transmission of control information and a first user-channel section for transmission of user data, said first control- and user-channel sections having as endpoints said access-network element and said transceiver station.

A control or user channel section in the present context is a part of a channel for control or user data, respectively, that extends from the network element of the invention to a next network element in the transmission path for control data or user data, respectively. Thus, the control and user channel sections controlled by the network element of the invention are normally part of a longer control and user channel, respectively, that Involves further network elements. Typically, a control channel for a MS to MS speech call involves different channel sections in access and core networks.

The network element of the invention further comprises a second call control unit communicating with said first call control unit and connected to said second interface, adapted to establish, maintain and release across said second interface in relation to said call a second control-channel section for transmission of control information and a second user-channel section for transmission of user data, said second control- and user-channel sections having as endpoints said first access-network element and a predetermined core-network element in said first core-network.

Thus, while the first call control unit is responsible for exchange of control and user data with a transceiver station communicating with a network terminal, the second call control unit is responsible for exchange of control and user data with other network elements towards the core network. The connection between the first and second control units allows transmitting user data and to translate control information received through one interface into corresponding control information transmitted through the other interface.

According to the invention, the first call control unit is additionally adapted to establish, maintain and release across said first interface a third user channel-section having as endpoints said first access-network element and a second access-network element in said first or second access network, respectively.

Therefore, the network element of the invention may switch the transmission path for user data from a transmission path through the core networks involved in a call to a transmission path through the access networks involved in this call. The advantages of this switching have been described above in the context of the method aspect of the present invention.

In a preferred embodiment the network element is adapted to releasing the second user channel section after a third transmission path for user data is established. That is, a user data connection with a peer network element involved in the ongoing call for the peer network terminal is established.

In a further embodiment the network element is adapted to assess whether the ongoing call is eligible for switching of the user data transmission from the first to the third user channel.

Further embodiments of the network element of the invention result from an implementation of the functionality according to the method of the invention and its numerous embodiments described herein.

The problem is also solved by a network system comprising a network element as described hereinabove.

### BRIEF DESCRIPTION OF THE DRAWINGS

In the following, the present invention will be described in greater detail based on a preferred embodiment with reference to the drawings figures, in which:

FIGS. 1a) and b) show in schematic diagrams the transmission of the control plane data and of the user plane data for a normal IP RAN CS call and for a Direct Routed IP RAN CS Call, respectively,

FIGS. 2a) and b) show in schematic diagrams the transmission of the control plane data and of the user plane data for a normal IP RAN PS call and a Direct Routed IP RAN PS call, respectively,

FIG. 3 shows a signaling flow to establish a Direct Routed CS call,

FIG. 4 shows a signaling flow to switch back to a normal CS or PS call from a Direct Routed CS or PS call,

FIG. 5 shows a signaling flow used to establish a Direct Routed PS call, and

FIG. 6 shows a signaling flow used for relocation of a Direct Routed PS or CS call from a first IP BTS to a second IP BTS.

### DESCRIPTION OF THE PREFERRED EMBODIMENT

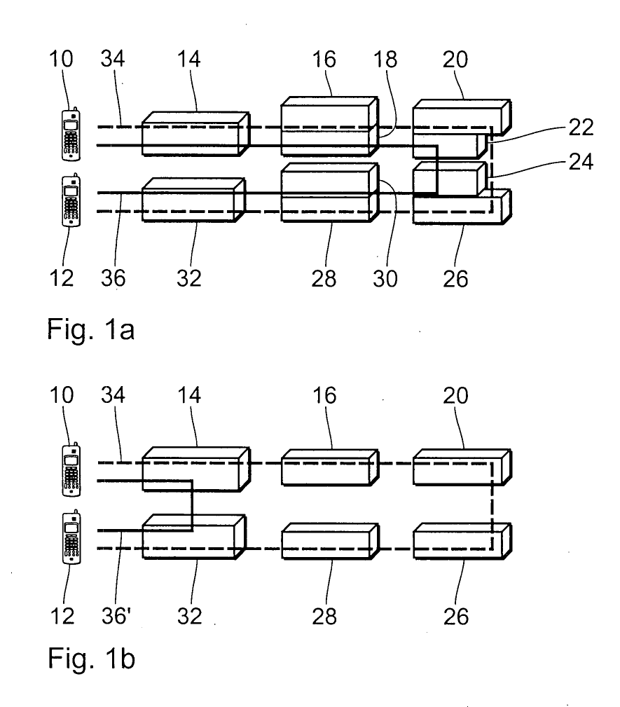

FIGS. 1a) and b) show in schematic diagrams the transmission path of the control plane data and of the user plane data for a IP RAN CS (Internet Protocol Radio Access Network Circuit switched) call before Direct Transmission has been established, and for a Direct Routed IP RAN CS Call, respectively. Direct Transmission and Direct Routing are used as synonyms in the context of this description.

First, the transmission scheme before the establishment of a Direct Routed IP RAN CS call will be described. A first terminal device, hereinafter also mobile station (MS) 10 is supposed to originate a CS call to a second terminal device 12. MS 10 and 12 will hereinafter also be called originating MS (O-MS) and terminating MS (T-MS) 12, respectively. On the network side originating the call, O-MS 10 is communicating with an Internet

Protocol Base Transceiver Station (IP BTS) 14 across a radio interface. IP BTS 14 implements the base station functionality of the IP RAN, e.g., air interface related protocols.

IP BTS 14 communicates with a Radio Network Access Server (RNAS) 16 in a radio access network (RAN). RNAS 16 provides control plane services at the interface between the RAN and the core network.

Beside RNAS 16 the RAN comprises a Circuit Switched Gateway (CSGW) 18. CSGW 18 provides an interface for user data between the IP RAN and the core network. Instead of user data also the term user plane data is used throughout this description with the same meaning, that is, data transmitted in the user plane of the transport protocol.

RNAS 16 communicates with one or several (originating) MSCs 20 in a related core network. The Mobile-services Switching Center (MSC) constitutes the interface between the radio system and the fixed networks. The MSC performs all necessary functions in order to handle the circuit switched services to and from the terminal devices. The Mobile-services Switching Center performs all the switching and signaling functions for terminal devices located in a geographical area designated as the MSC area. The MSC takes into account the impact of the allocation of radio resources and the mobile nature of the subscribers. It provides procedures required for the location registration and procedures required for handover. The core network also comprises an (originating) Media Gateway 22.

The network structure on the terminating side corresponds to that on the originating side. Thus, a (terminating) Media Gateway 24 and one or several (terminating) MSCs 26 are provided in the terminating core network. The RAN on the terminating side comprises a Radio Network Access Server (RNAS) 28 and a Circuit Switched Gateway (CSGW) 30, both communicating with a (terminating) IP BTS 32.

The transmission path for control data of the CS speech call between O-MS 10 and T-MS 12 in the control plane before switching to direct transmission is shown by a dashed line 34. The control data is routed from O-MS 10 to IB BTS 14, then to RNAS 16, MSC 20. From there it is routed via MSC 26, RNAS 28 and IP BTS 32 to T-MS 12.

The transmission path of user data of the CS speech call between O-MS 10 and T-MS 12 in the user plane before switching to direct transmission is shown by a full line 36 in FIG. 1a. The user data is routed from O-MS 10 to IP BTS 14, then to CSGW 18, MGW 22, MGW24, CSGW 30, IP BTS 32, and finally to T-MS 12. The transmission path of user data before switching to direct transmission corresponds to the case of a normal prior-art IP RAN CS call, in which the user plane is routed via the CN.

FIG. 1b) shows the transmission path for user plane data and control plane data after switching to direct transmission. FIG. 1b) uses the same reference numbers as FIG. 1a) for identical network elements. The description in the following concentrates on the differences to FIG. 1a).

In such a Direct Routed IP RAN CS call, the user plane is routed directly between the IP BTSs 14 and 32. This is shown in FIG. 1b by full line 36′. For a Direct Routed call the user data is routed in the user plane directly between IP BTS14 and IP BTS 32. All network elements in the user plane, that are not necessary for transmission of user plane data, have been omitted in FIG. 1b) in comparison to FIG. 1a). Especially, CSGWs 18 and 28 as well as MGWs 22 and 24 are released from the transmission of user plane data.

This type of call configuration is saving transport resources in the core and reducing the delay on the speech transmission. In addition, transport resources in the RAN are saved, because no data is sent through the CSGWs 18 and 28.

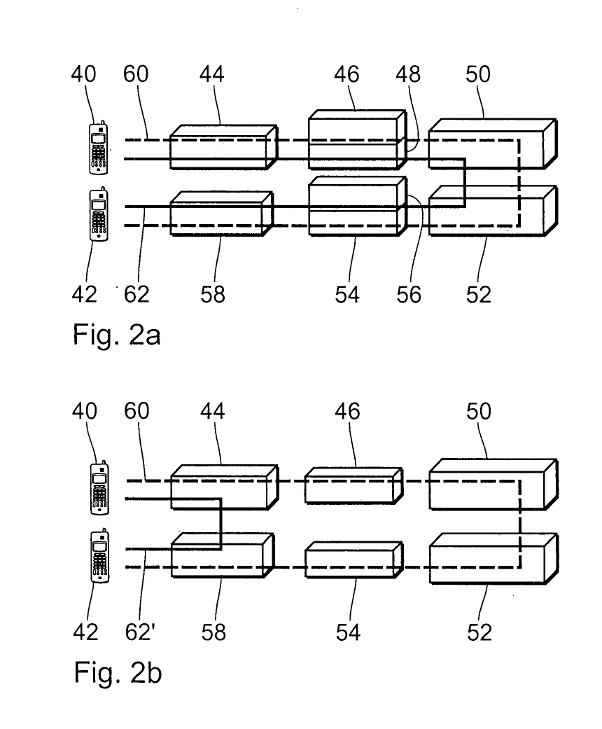

FIGS. 2a) and b) show in schematic diagrams the transmission path of the control plane data and of the user plane data for a IP RAN PS (Internet Protocol Radio Access Network Packet switched) call before Direct Transmission has been established, and for a Direct Routed IP RAN PS Call, respectively.

First, the transmission scheme before the establishment of a Direct Routed IP RAN PS call will be described. A first mobile station MS 40 is supposed to originate a PS call to a second MS 42. MS 40 and 42 will hereinafter also be called originating MS (O-MS) 40 and terminating MS (T-MS) 42, respectively.

On the network side originating the call, O-MS 40 is communicating with an Internet Protocol Base Transceiver Station (IP BTS) 44 across a radio interface. IP BTS 44 implements the base station functionality of the IP RAN, e.g., air interface related protocols. IP BTS 44 can be adapted to operation for CS and PS calls.

IP BTS 44 communicates with a Radio Network Access Server (RNAS) 46 in a RAN. RNAS provides an interface for control plane data on the CN side of the RAN. Beside RNAS 46 the RAN comprises a Radio Network Gateway (RNGW) 48. RNGW 48 provides an interface for user data for PS calls between the IP RAN and the core network. RNAS 46 communicates with one or several (originating) Serving GPRS Support Nodes (SGSNs)/Gateway GPRS Support Nodes (GGSNs) 50 in a related core network. The GSNs perform all the switching and signaling functions for in order to handle the packet transmission to and from terminal devices located in a geographical area designated as the SGSN area. They take into account the impact of the allocation of radio resources and the mobile nature of the subscribers. They provide procedures required for the location registration and procedures required for handover.

The network structure on the terminating side corresponds to that on the originating side. Thus, one or several (terminating) SGSNs/GGSNs 52 are provided in the terminating core network. The RAN on the terminating side comprises a Radio Network Access Server (RNAS) 54 and a Radio Network Gateway (RNGW) 56, both communicating with a (terminating) IP BTS 58.

The transmission path for control data of the CS speech call between O-MS 40 and T-MS 42 in the control plane before switching to direct transmission is shown by a dashed line 60. The control data is routed from O-MS 40 to IB BTS 44, then to RNAS 46, SGSN/GGSN 50. From there it is routed via SGSN/GGSN 52, RNAS 54 and IP BTS 58 to T-MS 42.

The transmission path of user data of the PS speech call between O-MS 40 and T-MS 42 in the user plane before switching to direct transmission is shown by a full line 62 in FIG. 2a. The user data is routed from O-MS 40 to IP BTS 44, then to RNGW 48, SGSN/GGSN 50, SGSN/GGSN 52, RNGW 56, IP BTS 58, and finally to T-MS 42. The transmission path of user data before switching to direct transmission corresponds to the case of a normal prior-art IP RAN PS call, in which the user plane is routed via the CN.

FIG. 2b) shows the transmission path for user plane data and control plane data after switching to direct transmission. As above, also FIG. 2b) uses the same reference numbers as FIG. 2a) for identical network elements. The description in the following concentrates on the differences to FIG. 2a).

In such a Direct Routed IP RAN PS call, the user plane is routed directly between the IP BTSs 44 and 58. This is shown in FIG. 2b by full line 62′. Network elements in the user plane of the PS domain, that are not necessary for transmission of user plane data, have been omitted in FIG. 2b) in comparison to FIG. 2a). Especially, RNGWs 48 and 56 are released from the transmission of user plane data.

Comparison of FIGS. 2a) and 2b) with FIGS. 1a) and 1b) shows that the same kind of optimization is achieved for the PS case as for the CS case. All IP BTSs shown in FIGS. 1a) through 2) may be adapted to serve both the CS and PS domains, so that the structures shown in FIGS. 1 and 2 can be realized using one core network system containing a PS domain and a CS domain and one RAN adapted accordingly for communication with both PS and CS domains.

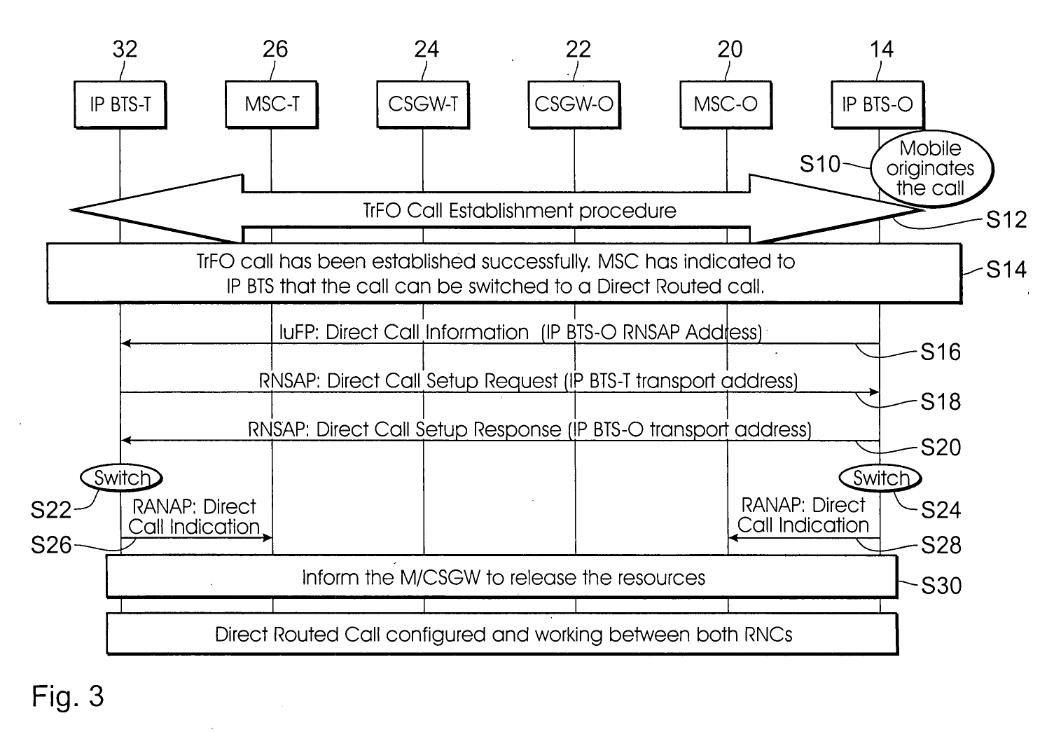

FIG. 3 shows in a flow diagram a procedure to be followed in order to setup a Direct Routed CS call.

In a step S10 the mobile originates the speech call. This call is an MS to MS call. During the call setup, a codec negotiation is performed (using known OoBTC procedures). If the codec negotiation is found successful, it means that this call is a candidate to be a TrFO call. At this moment, in a step S12) specific Radio Access Bearer (RAB) assignment and User Plane (UP) initialization take place, and the TrFO call is successfully completely established.

After the call has been completely established, each MSC 20 and 26 indicates in a step S14 to the corresponding IP BTS 14 and 32, respectively, that the call can be switched to be a Direct Routed call. MSCs 20 and 26 may also inform the corresponding IP BTS about the role that it is performing in the call (terminating or originating). This indication could be done introducing a flag in the last RANAP (Radio Access Network Application Part) message sent to the corresponding IP BTS during the call setup procedure. This last RANAP message is named a Direct Transfer message and contains the known “CONNECT ACKNOWLDGE” message. In this way both IP BTSs would be aware that the call can be switched to be Direct Routed, and of the role that each IP BTS is performing.

In an alternative method, instead of the MSCs 20 and 26, the originating IP BTS 14 decides that this TrFO call is a candidate to be a Direct Routed call.

The procedure to setup the Direct Routed call starts with a step S16, in which the originating IP BTS 14 sends an IuFP (Iu Framing Protocol) message. This message is named for example “Direct Call Information”. This IuFP message is including the originating IP BTS RNSAP (Radio Network Subsystem Application Part) signaling address needed for the direct RNSAP communication between IP BTSs 14 and 32.

Terminating IP BTS(-T) 32 receives this IuFP message and notices that the call should be reconfigured to be a Direct Routed call. In a step S18 it sends a RNSAP message including the terminating IP BTS's 32 transport address towards the originating IP BTS 14. The transport address is needed for the direct transmission of the user data. This message is given the name “Direct Call Setup Request”.

The Originating IP BTS 14 receives this RNSAP message, stores the originating IP BTS transport address, and responds in a step S20 by sending an RNSAP message including its own transport address. This message is given the “Direct Call Setup Response”.

Now, both IP BTSs 14 and 32 have the needed information to switch the call to be a Direct Routed call, so the switch is performed in steps S22 and S24. From now on the user data for this call will be routed directly between both IP BTSs, not going through the CN.

Finally, both IP BTSs 14 and 32 inform their corresponding MSCs 20 and 26, respectively, about the reconfiguration performed to the call. Both IP BTSs send to their MSC a RANAP message indicating this new situation for the call. This message is named “Direct Call Indication”.

After being informed about this reconfiguration for a call, MSCs 20 and 26 inform in a step S30 their corresponding CSGWs 22 and 24, respectively, about the non-use of the resources for the call so they can be released. This step is optional and need may be omitted in an alternative embodiment.

At this point the Direct Routed call is completely configured and working between IP BTSs. MSCs 20 and 26 keep track of the calls that are operating as Direct Routed calls.

The method for establishing a Direct Routed CS call may be summarized as follows:
1. Normal TrFO call is setup (user plane via the core network).
2. Originating IP BTS and Terminating IP BTS negotiate the use of direct routing and exchange transport addresses for Direct Routing purposes.
3. O-IP BTS and T-IP BTS ask for authorization to core network for Direct Routed calls (optional).
4. O-IP BTS and T-IP BTS switch the call to Direct Routed calls with handshake.
5. O-IP BTS and T-IP BTS inform the core network of Direct Routed call on going (note: the core still keep the transport address reserved, but can release the resources associated to it).

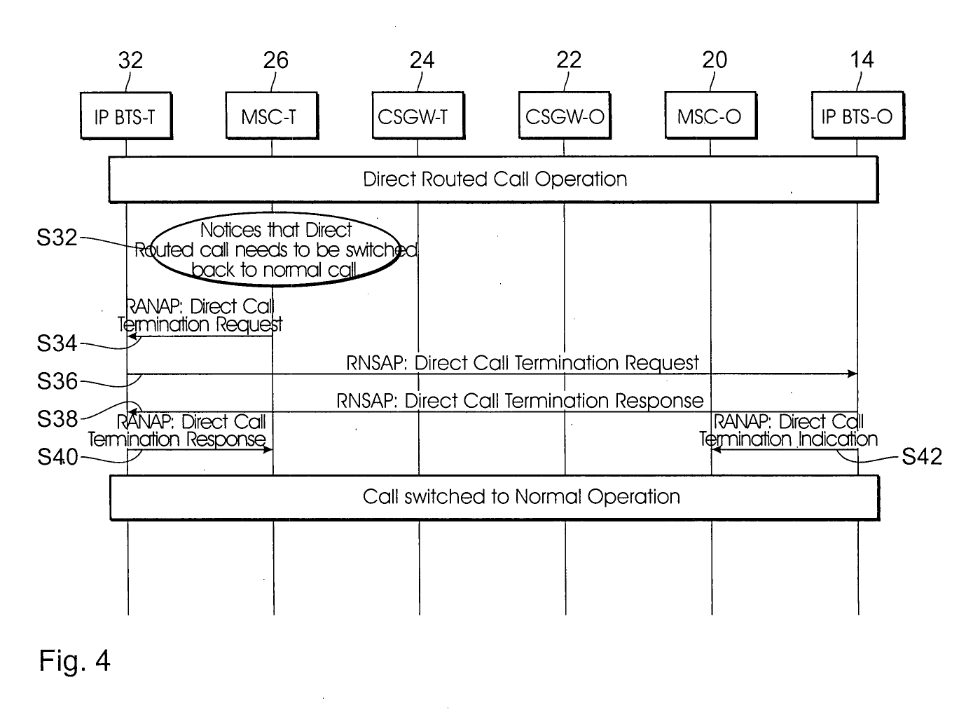

MSCs 20 and 26 will be able to request a switch back to normal operation of the call. This will be described below with reference to FIG. 4.

FIG. 4 shows in a flow diagram a procedure to be followed in order to terminate a Direct Routed CS call. The diagram applies as well to the case of terminating a Direct Routed PS call. Only the network elements for CS operation shown in FIG. 4 have to be replaced by those for PS operation. Thus, MSC-O 20 and MSC-T 26 would have to be replaced by SGSN/GGSN-O 50 and SGSN/GGSN-T 52, respectively. CSGW-O 22 and CSGW-T 24 would have to be replaced by RNGW-O 48 and RNGW-T 56, respectively. The following description will only use the network elements of the CS case, bearing in mind, however, that it can be translated into the PS case using the above replacements.

When a CS call is working in Direct Transmission configuration operation, the CN (MSC) can detect that the call has to be switched back to normal operation. This switch back can be due to the limitations mentioned earlier. The MSC detecting this situation can be the terminating MSC 26 or the originating MSC 20. In the present example MSC-T 26 is supposed to notice that the Direct Routed call needs to be switched back to a normal call.

After detecting this situation in a step S32, in a further step S 34 MSC 26 sends a RANAP message to the corresponding IP BTS-T 32, requesting the switch back to normal operation of the Direct Routed call. This message is given the name “Direct Call Termination Request”. If MSC-O were to notice the need to switch back, this message would be sent to IP BTS-O 14.

After receiving this request message, IP BTS-T 32 informs the peer IP BTS-O 14 about the request in a step S36 by sending a RNSAP message requesting the switch back to normal operation for the call. This message is for example given the “Direct Call Termination Request”.

IP BTS-O 14 receives this RNSAP request message and responds in a step S 38 with another RNSAP message acknowledging that the call switch back to normal operation is going to be performed. This message is given the name Direct Call Termination Response.

At this moment both IP BTSs 14 and 32 will switch the call back to normal operation and inform each MSC about this in steps S40 and S42. In step S40, IP BTS-T 32 sends to its MSC-T 26 a RANAP message. The name for this is for example “Direct Call Termination Response”. IP BTS-O indicates its MSC-O 20 about the new configuration for the call in step S42 by sending a RANAP message named for example “Direct Call Termination Indication”.

At this point the CS call has been switched back to normal operation, and the user plane is routed again through the CN.

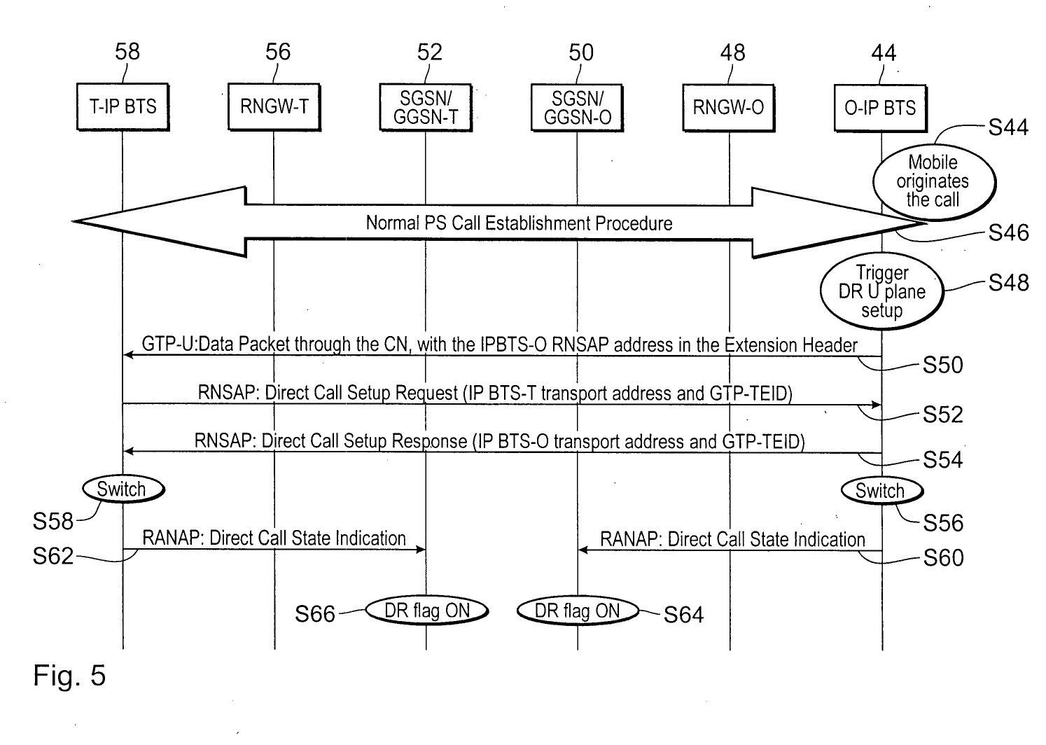

FIG. 5 shows a signaling flow for establishing a Direct Routed PS call.

In establishing a Direct Routed PS call, first, MS 40 is assumed to originate the PS call in a step S44. The example could equally be explained by assuming MS 42 to originate the call. This call is an MS to MS call. The call establishment is performed as for a normal PS call in a step S46.

After the call has been completely established, the originating IP BTS 44 initiates the procedure to setup the Direct Routed call in a step S48. In an alternative embodiment, each CN could inform, during call establishment, the corresponding IP BTS that the call can be switched to a Direct Routed operation and about the role of each IP BTS performed in the communication (Originating or Terminating). Also the CN could inform the IP BTS about the transport address needed for Direct Transmission purposes.

When the originating IP BTS 44 sends the first GTP data packet (G-PDU) in a step S50 through the core network, it will include in the G-PDU header a new Extension Header. This new Extension Header will include all the needed information in order to perform the Direct Transmission between the IP BTSs, i.e., RNSAP address of IP BTS 44 or network element (NE) ID for the RNSAP routing.

The Extension Header will be interpreted by GGSN 50 (endpoint receiver). In forwarding the G-PDU to the next intermediate receiver, SGSN 52, GGSN 50 will copy the Extension Header to the header of the forwarded G-PDU. The terminating IP BTS endpoint receiver 58 will interpret this Extension Header.

The terminating IP BTS 58 receives the first G-PDU and interprets the Extension Header included. It notices that the call is to be Direct Routed and extracts the needed information from the Extension Header. In a step S52 it sends towards the originating IP BTS 44 an RNSAP message including the terminating IP BTS transport address and GTP-TEID, needed for the direct routing of the user data. This message is given the name Direct Call Setup Request. The abbreviation TEID refers to a TUNNEL ENDPOINT IDENTIFIER (TEID). The TEID unambiguously identifies a tunnel endpoint in the receiving GTP-U (user plane) or GTP-C (control plane) protocol entity. The receiving end side of a GTP tunnel locally assigns the TEID value the transmitting side has to use. The TEID values are exchanged between tunnel endpoints using GTP-C (or RANAP, over the Iu) messages.

Originating IP BTS 44 receives this RNSAP message, stores the terminating IP BTS 58 transport address and GTP-TEID, and responds in a step S54 by sending an RNSAP message including its own transport address and GTP-TEID. This message is given the name Direct Call Setup Response.

Now, both IP BTSs 44 and 58 have the needed information to switch the call to be a Direct Routed call, so the switch is performed in steps S56 and S58. From now on the user data for this call will be routed directly between both IP BTSs, not going through the CN.

In steps S60 and S62 both IP BTSs will inform to the SGSNs 50 and 52, respectively, about the reconfiguration performed to the call, so it will be able to request the switch back to normal operation of the call. Both IP BTSs send to their respective SGSN a RANAP message indicating this new situation for the call. The name of this message could be for example Direct Call Indication.

SGSNs 50 and 52 should keep track of the calls that are operating as Direct Routed calls by setting flags in steps S64 and S66, respectively.

At this point the Direct Routed PS call is completely configured and working between IP BTSs.

The method of establishing a Direct Routed PS call can be summarized as follows:
1. Normal PS call is set up (user plane via the CN).
2. O-IP BTS sends the needed information for the Direct Routing (,i.e., RNSAP address) to the T-IP BTS in the first G-PDU sent.
3. T-IP BTS receives the needed information and initiates the negotiation for using Direct Routing and the exchange of the transport addresses and GTP-TEIDs for this purpose.
4. O-IP BTS and T-IP BTS ask for authorisation to core network for Direct Routed calls (optional).
5. O-IP BTS and T-IP BTS switch the call to Direct Routed calls with handshake.
6. O-IP BTS and T-IP BTS inform the Core network of Direct Routed call on going (note: the core network still keep the transport address reserved, but can release the resources associated to it).

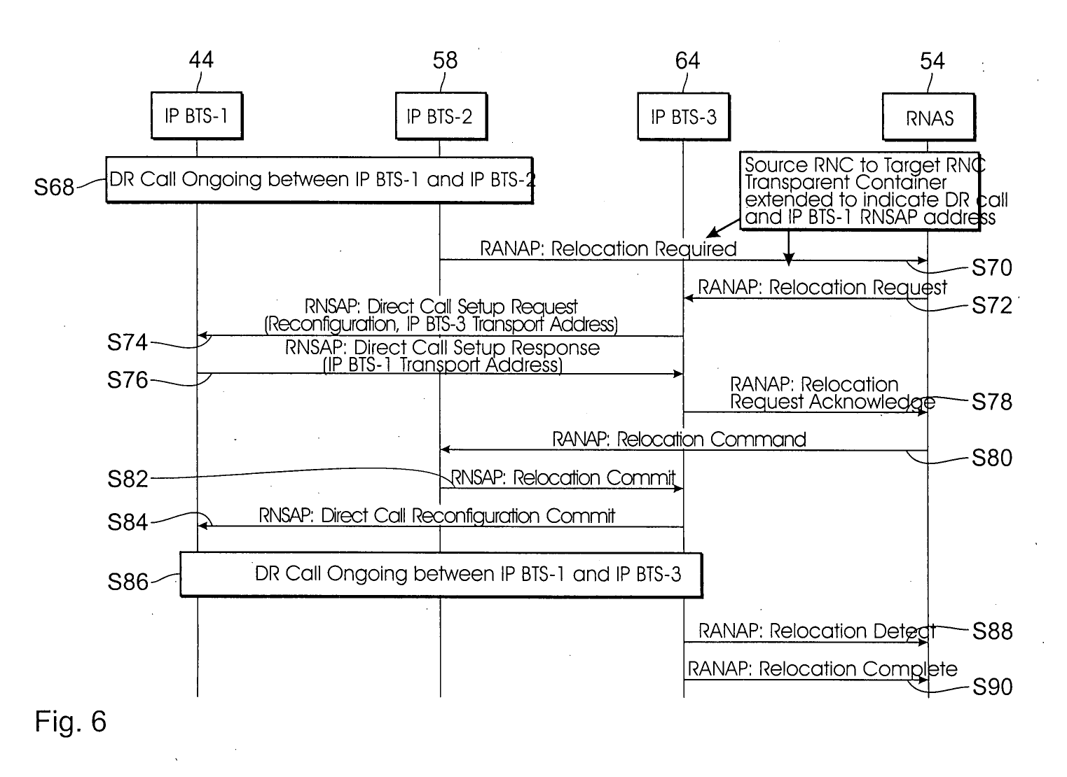

With reference to FIG. 6, a relocation procedure for both, PS and CS cases, will be described. The relocation procedure within an IP RAN is not involving the CN, so this procedure is the same for CS and PS cases.

When a call is working in Direct Routing configuration operation in a step S68, it may become subject to be relocated from one IP BTS 58, also shown as IP BTS-2 in FIG. 6, to another IB BTS 64, also shown as IP BTS-3.

IP BTS-2 58 (Source IP BTS being relocated) sends a RANAP Relocation Required message to RNAS 54 in a step S70. For this purpose the known RANAP message is modified according to the present invention in order to include the RNSAP address of IP BTS-1 44. This additional information could be transmitted by extending the Source RNC to Target RNC Transparent Container.

Since RNAS 54 does not know about the Direct Routed call configuration and just relays the modified RANAP message to IP BTS-3 (Target IP BTS) in a step S72. The modified RANAP will be referred to as RANAP′ in the following.

IP BTS-3 64, the Target IP BTS, receives the RANAP′ message and notices that the call being relocated is a Direct Routed call. It starts to configure the call to be Direct Routed. For this purpose it sends ion a step S74 to IP BTS-1 44 an RNSAP message indicating the Direct Routed call reconfiguration and its Transport Address information. In the PS case it includes the GTP-TEID information. This RNSAP message can be the same used in the setup procedure Direct Call Setup Request, indicating reconfiguration of the call.

IP BTS-1 44 receives the RNSAP message and responds in a step S76 to IP BTS-3 64 with, for example, RNSAP Direct Call Setup Response, including its Transport Address information. In the PS case it includes also the GTP-TEID information.

IP BTS-3 64 receives the RNSAP message and continues with the normal relocation procedure, sending to RNAS 54 a RANAP′ Relocation Request Acknowledge message in a step S78.

When receiving this message, RNAS 54 will send to IP BTS-2 58 the RANAP′ Relocation Command message in a step S80. And again, following with the normal procedure, when receiving this message, IP BTS-2 58 sends to IP BTS-3 64 the RNSAP Relocation Commit message in a step S82.

IP BTS-3 64 receives the RNSAP message and sends in a step S84 an RNSAP message to the IP BTS-1 44 in order to indicate that the relocation procedure has finished. This message is named Direct Call Reconfiguration Commit.

After this step, both IP BTS-1 and IP BTS-3 can communicate to each other in a Stepp S86. The normal relocation procedure will be finished by IP BTS-3 64 by sending in a step S88 and S90 the RANAP′ Relocation Detect and Relocation Complete messages to RNAS 54.

It is noted that the present invention mainly relates to the IP RAN, but it is applicable also to the conventional RAN (GSM BSS and UTRAN). In that case, the term IP BTS must be interpreted as BSC or RNC, respectively. The invention is applicable mainly for speech CS calls and voice over IP PS calls, but also to video-telephony and instant messaging services.

1-35. (canceled)

36. A method for direct transmission of user data related to a call involving a first terminal device attached to a first access network and a second terminal device attached to a second access network comprising the steps of
establishing a first transmission path for said user data, said first transmission path comprising
said first access network
a first core network communicating with said first access network,
a second core network communicating with said first core network, and
said second access network communicating with said second core network,
switching from said first transmission path to a second transmission path for said user data, said second transmission path comprising a direct connection between said first access network and said second access network, wherein, before said step of establishing said first transmission path for said user data, a step of establishing a third transmission path for control data related to said call is performed, and
wherein, before said step of switching from said first transmission path to said second transmission path for said user data, a handshake between at least one first access-network element involved in said first transmission path in said first access network and at least one second access-network element involved in said first transmission path in said second access network is performed, said handshake comprising a step of providing from the at least one first access-network element to the at least one second access-network element first control information indicating that said direct transmission of user data between said first and second access networks is possible.

37. A method according to claim 36, wherein said third transmission path comprises the same networks as said first transmission path for user data.

38. A method according to claim 36, wherein said third transmission path remains unchanged before and after said step of switching from said first transmission path to said second transmission path.

39. A method according to claim 36, wherein said first, second, and third transmission paths involve a first access-network element in said first access network, and a second access-network element in said second access-network.

40. A method according to claim 36, wherein said first control information comprises a first information element indicating that in relation to said call said first or second access-network element has the role of an originating or a terminating access-network element, respectively.

41. A method according to claim 36, wherein said step of providing said first control information is performed during said step of establishing a third transmission path for control data related to said call.

42. A method according to claim 36, wherein said step of providing first control information comprises a step of transferring second control information from said first access-network element to said second access-network element, or vice versa, said second control information containing a transport address of said first or second access-network element, respectively.

43. A method according to claim 42, comprising, before said step of switching from said first transmission path to said second transmission path for said user data, a step of responding to said second control information by transferring third control information from the access-network element receiving said second control information to the access-network sending said second control information, said third control information containing a transport address of the respective access-network element having received said second control information.

44. A method according to claim 36, comprising, after said step of switching from said first transmission path to said second transmission path for said user data, a step of transferring fourth control information from said first access-network element to said first core-network element and/or from said second access-network element to said second core-network element, said fourth control information indicating that said step of switching from said first transmission path to said second transmission path for said user data related to said call has been performed successfully.

45. A method according to claim 44, comprising, after said step of transferring said fourth control information, a step of saving said fourth control information for later use by said first and/or second core-network element, respectively.

46. A method according to claim 44, comprising, after said step of transferring said fourth control information, a step of forwarding said fourth control information from said first and/or second core-network element to further core-network elements in the first and/or second core-network, respectively, that are involved in said first transmission path.

47. A method according to claim 36, wherein, after said step of switching from said first transmission path to said second transmission path for said user data related to said call, a step of switching back to said first transmission path for user data is performed under predetermined conditions.

48. A method according to claim 47, comprising, before said step of switching back to said first transmission path, a step of transferring fifth control information from said first core-network element and/or said second core-network element to said first access-network element and/or said second access-network element, respectively, said fifth control information indicating a request to switch back the transmission path for user data to said first transmission path.

49. A method according to claim 47, comprising, before said step of switching back from said second transmission path to said first transmission path for said user data, a step of performing a handshake between said first and second access-network elements.

50. A method according to claim 47, comprising, before said step of switching back to said first transmission path, a step of transferring sixth control information from the access-network element receiving said fifth control information to the other access-network element involved in said second transmission path, said sixth control information indicating a request to switch back the transmission path of user data to said first transmission path.

51. A method according to claim 50, comprising, before said step of switching back to said first transmission path, a step of transferring seventh control information from the access-network element receiving said sixth control information to the access-network element sending said sixth control information, said seventh control information indicating acknowledging the coming switch back of the transmission path of user data to said first transmission path.

52. A method according to claim 47, comprising, after said step of switching back to said first transmission path, a step of transferring eighth control information from said first and/or second access-network element to said first and/or second core network element, said eighth control information indicating that said step of switching back to said first transmission path has been performed successfully.

53. A method according to claim 36, comprising, before said step of switching from said first transmission path to said second transmission path for said user data, a step of transferring ninth control information from said first and/or second access-network elements to said first and/or second core-network elements, respectively, said ninth control information indicating that switching to said second transmission path is intended.

54. A method according to claim 53, comprising, before said step of switching from said first transmission path to said second transmission path for said user data, a step of transferring tenth control information from said first or second core-network elements to said first and/or second access-network elements, respectively, said tenth control information indicating authorization to switch to said second transmission path.

55. A method according to claim 36, wherein said call is of a circuit-switched connection type.

56. A method according to claim 55, wherein said step of establishing said third transmission path for control data comprises a step of negotiating a mechanism of coding and decoding of user data between the networks.

57. A method according to claim 55, wherein said step of transferring said first and/or said second control information from said first access-network element to said second access-network element is performed using said third transmission path.

58. A method according to claim 36, wherein said call is of a packet-switched connection type.

59. A method according to claim 58, wherein said step of transferring said first control information from said first access-network element to said second access-network element is performed using said first transmission path for user data.

60. A method according to claim 59, wherein said first control information is contained in a first data packet transferred between said first and second access-network elements after said step of establishing said first transmission path.

61. A method according to claim 59, wherein said first and/or second control information is contained in at least one extension header of said first data packet, and said second control information comprises said transport address of the access-network element sending said first data packet.

62. A method according to claim 58, wherein said step of transferring said second control information from said first access-network element to said second access-network element comprises a step of forwarding said second control information from said first core-network element to said second core-network element in a second data packet.

63. A method according to claim 58, wherein said step of forwarding said control information from said first core-network element to said second core-network element comprises a step of copying said extension header to said second data packet.

64. A method according to claim 58, wherein said step of responding to said second control information comprises a step of transferring said third control information in a third data packet from the access-network element receiving said second control information to the access-network element sending said second control information.

65. A method according to claim 64, wherein said third control information is contained in at least one extension header of said first data packet, and said third control information comprises said transport address of the access-network element receiving said first data packet.

66. A first network element for controlling the operation of at least one transceiver station in a first access network in relation to a call between a first network terminal attached to said first access network and a second network terminal attached to a second access network, comprising
at least one first interface adapted to exchange control information and user data with said transceiver station,
at least one second interface adapted to exchange control information and user data with a first core-network,
a first call control unit connected to said first interface, and adapted to establish, maintain and release across said first interface in relation to said call a first control-channel section for transmission of control information and a first user-channel section for transmission of user data, said first control- and user-channel sections having as endpoints said network element and said transceiver station,
a second call control unit communicating with said first call control unit and connected to said second interface, adapted to establish, maintain and release across said second interface in relation to said call a second control-channel section for transmission of control information and a second user-channel section for transmission of user data, said second control- and user-channel sections having as endpoints said first network element and a predetermined core-network element in said first core-network,
wherein said first call control unit is additionally adapted to establish, maintain and release across said first interface a third user channel-section for user data related to said call having as endpoints said first network element and a second network element in said second access network, respectively, and
wherein said first network element is adapted to perform a handshake directly between said first network element and said second network element after establishing said second control channel section and before establishing said third user channel section, said handshake comprising a step of providing from the first network element to the second network element first control information indicating that said direct transmission of user data between said first and second access networks is possible.

67. A network element according to claim 66 that is adapted to releasing said second user-channel section after said third user channel section is established.

68. A network element according to claim 66, that is adapted to assess whether an ongoing call is eligible for establishing said third user channel section.

69. A network element according to claim 66, additionally configured to perform the steps of
establishing a first transmission path for said user data, said first transmission path comprising
said first access network
a first core network communicating with said first access network,
second core network communicating with said first core network, and
said second access network communicating with said second core network,
switching from said first transmission path to a second transmission path for said user data, said second transmission path comprising a direct connection between said first access network and said second access network, wherein, before said step of establishing said first transmission path for said user data, a step of establishing a third transmission path for control data related to said call is performed, and
wherein, before said step of switching from said first transmission path to said second transmission path for said user data, a handshake between at least one first access-network element involved in said first transmission path in said first access network and at least one second access-network element involved in said first transmission path in said second access network is performed, said handshake comprising a step of providing from the at least one first access-network element to the at least one second access-network element first control information indicating that said direct transmission of user data between said first and second access networks is possible.

70. Network system comprising a network element according to claim 66.
